(19) United States
(12) Patent Application Publication
(10) Pub. No.: US 2023/0166690 A1
(43) Pub. Date: Jun. 1, 2023

(54) Vehicle and Control Method Thereof

(71) Applicants: Hyundai Motor Company, Seoul (KR); Kia Corporation, Seoul (KR)

(72) Inventor: Jaeryong Choi, Yongin-si (KR)

(21) Appl. No.: 17/939,167

(22) Filed: Sep. 7, 2022

(30) Foreign Application Priority Data
Nov. 30, 2021 (KR) 10-2021-0169206

(51) Int. Cl. B60S 1/08; B60Q 1/52

(52) U.S. Cl. CPC B60S 1/0844; B60S 1/0837; B60S 1/0807; B60Q 1/52

(57) ABSTRACT

An embodiment vehicle includes a rain sensor configured to generate a splash signal in response to detecting rain greater than or equal to a predetermined amount, a wiper driver configured to operate a wiper based on the splash signal, a first controller configured to transmit the splash signal to the wiper driver, and a second controller configured to receive the splash signal from the first controller, generate a control signal based on the splash signal, and operate at least one electronic device based on the control signal.

### CROSS-REFERENCE TO RELATED APPLICATIONS

This application claims the benefit of Korean Patent Application No. 10-2021-0169206, filed on Nov. 30, 2021, which application is hereby incorporated herein by reference.

### TECHNICAL FIELD

The disclosure relates to a vehicle and a control method thereof.

### BACKGROUND

When driving in the rain, a large amount of rain splashes on the windshield of the vehicle due to instantaneous friction between the road surface and the tires of nearby vehicles, causing an unexpected situation which increases the risk of accident.

A vehicle may be equipped with a rain sensor to improve a driver's convenience in driving in the rain. The rain sensor automatically controls operations of wipers by detecting an intensity and the amount of rainfall without a driver's separate operation.

However, even a vehicle equipped with a rain sensor may not prepare for a large amount of instantaneous rainfall, and thus the best alternative plan is required in an unavoidable emergency.

### SUMMARY

The disclosure relates to a vehicle and a control method thereof. Particular embodiments relate to a vehicle including a rain sensor and a control method thereof.

An embodiment of the disclosure provides a vehicle and a control method thereof that may use a detection signal of a rain sensor for other control devices.

According to an embodiment of the disclosure, there is provided a vehicle including a rain sensor configured to generate a splash signal in response to detecting rain greater than or equal to a predetermined amount, a wiper driver configured to operate a wiper based on the splash signal, a first controller configured to transmit the splash signal to the wiper driver, and a second controller configured to receive the splash signal from the first controller, generate a control signal based on the splash signal, and operate at least one electronic device based on the control signal.

The wiper driver is configured to operate the wiper according to a power mode for reducing a wiping angle of the wiper when the splash signal is detected.

The wiper driver is configured to shorten a wiping cycle of the wiper in the power mode.

The vehicle further includes a memory configured to store image data, wherein the at least one electronic device includes a camera mounted on the vehicle and configured to acquire the image data including a front image or a rear image, and the second controller is configured to control the memory to store the image data based on the control signal.

The at least one electronic device includes a communicator configured to transmit and receive data with a nearby vehicle, and the second controller is configured to control the communicator to transmit a warning signal to the nearby vehicle in response to receiving the control signal.

The at least one electronic device includes a lamp configured to blink in an emergency, and the second controller is configured to control the lamp to blink in response to receiving the control signal.

The power mode is automatically activated in the wiper driver, when a nearby vehicle is detected within a predetermined distance from a rear of the vehicle.

The rain sensor is configured to generate the splash signal in response to detection of the nearby vehicle.

The vehicle further includes a communicator configured to transmit and receive data with the nearby vehicle, and the second controller is configured to control the communicator to transmit a warning signal to the nearby vehicle in response to detection of the nearby vehicle.

The power mode is automatically activated in the wiper driver, when a speed of the vehicle is greater than or equal to a predetermined speed.

According to an embodiment of the disclosure, there is provided a control method of a vehicle including a rain sensor, a wiper driver, a first controller, and a second controller, the control method including generating, by the rain sensor, a splash signal in response to detecting rain greater than or equal to a predetermined amount, operating, by the wiper driver, a wiper based on the splash signal, transmitting, by the first controller, the splash signal to the wiper driver, receiving, by the second controller, the splash signal from the first controller, generating, by the second controller, a control signal based on the splash signal, and operating, by the second controller, at least one electronic device based on the control signal.

The operating the wiper includes operating the wiper according to a power mode for reducing a wiping angle of the wiper.

A wiping cycle of the wiper is shortened in the power mode.

The operating the at least one electronic device includes controlling a memory to store image data obtained by a camera mounted on the vehicle based on the control signal.

The operating the at least one electronic device includes controlling a communicator to transmit a warning signal to a nearby vehicle in response to receiving the control signal.

The operating the at least one electronic device includes controlling a lamp to blink in response to receiving the control signal.

The control method further includes automatically activating the power mode, when a nearby vehicle is detected within a predetermined distance from a rear of the vehicle.

The control method further includes generating the splash signal in response to detection of the nearby vehicle.

The operating the at least one electronic device includes controlling a communicator to transmit a warning signal to the nearby vehicle in response to detection of the nearby vehicle.

The control method further includes automatically activating the power mode, when a speed of the vehicle is greater than or equal to a predetermined speed.

### BRIEF DESCRIPTION OF THE DRAWINGS

These and/or other aspects of embodiments of the disclosure will become apparent and more readily appreciated from the following description of the embodiments, taken in conjunction with the accompanying drawings, in which:

FIG. 1 illustrates an exterior of a vehicle according to an embodiment;

FIG. 2 illustrates an interior of a vehicle according to an embodiment;

FIG. 3 illustrates a signal flow graph of an existing rain sensor system;

FIG. 4 is a diagram illustrating a configuration of a rain sensor system according to an embodiment;

FIG. 5 illustrates a signal flow graph of a rain sensor system according to an embodiment;

FIG. 6 is a flowchart illustrating a control method of a vehicle according to an embodiment;

FIG. 7 is a diagram illustrating an operation radius of a wiper in a power mode of a rain sensor system according to an embodiment; and

FIG. 8 is a flowchart illustrating a control method of a vehicle according to another embodiment.

### DETAILED DESCRIPTION OF ILLUSTRATIVE EMBODIMENTS

Like reference numerals throughout the specification denote like elements. Also, this specification does not describe all the elements according to embodiments of the disclosure, and descriptions well-known in the art to which the disclosure pertains or overlapped portions are omitted. The terms such as “—part”, “—member”, “—module”, “—block”, and the like may refer to at least one process processed by at least one hardware or software. According to embodiments, a plurality of “—parts”, “—members”, “—modules”, “—blocks” may be embodied as a single element, or a single of “—part”, “—member”, “—module”, “—block” may include a plurality of elements.

It will be understood that when an element is referred to as being “connected” to another element, it can be directly or indirectly connected to the other element, wherein the indirect connection includes “connection” via a wireless communication network.

It will be understood that the term “include” when used in this specification specifies the presence of stated features, integers, steps, operations, elements, and/or components, but does not preclude the presence or addition of one or more other features, integers, steps, operations, elements, components, and/or groups thereof.

It will be understood that when it is stated in this specification that a member is located “on” another member, not only a member may be in contact with another member, but also still another member may be present between the two members.

It will be understood that, although the terms first, second, etc. may be used herein to describe various elements, these elements should not be limited by these terms.

It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

Hereinafter, an operation principle and embodiments will be described in detail with reference to the accompanying drawings.

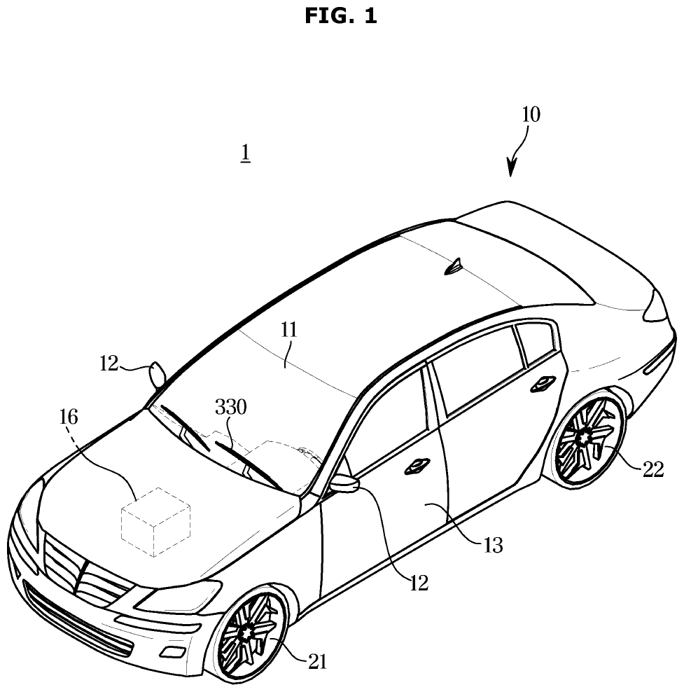

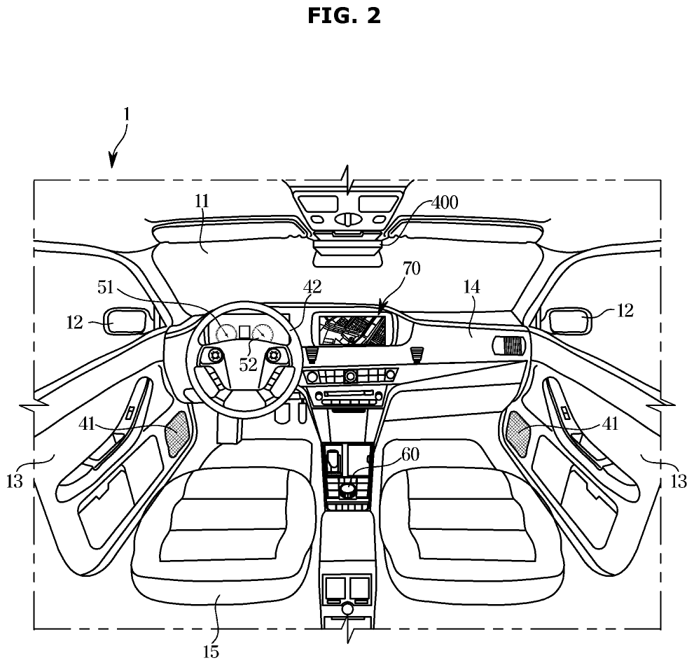

FIG. 1 illustrates an exterior of a vehicle according to an embodiment. FIG. 2 illustrates an interior of a vehicle according to an embodiment.

Referring to FIG. 1, an exterior of a vehicle 1 may include a vehicle body 10, a windshield glass 11, side mirrors 12, doors 13, and vehicle wheels 21 and 22. The vehicle body 10 defines the exterior of the vehicle 1, and the windshield glass 11 provides a driver with a front field of view of the vehicle 1. The side mirrors 12 provide the driver with a rear field of view of the vehicle 1, and the doors 13 shield the inside of the vehicle 1 from the outside. The vehicle wheels 21 and 22 for moving the vehicle 1 include front wheels 21 located at a front end of the vehicle 1 and rear wheels 22 located at a rear end of the vehicle 1.

The windshield glass 11 is provided on a front upper side of the vehicle body 10 so that the driver inside the vehicle 1 may acquire visual information about the front of the vehicle 1. Also, the side mirrors 12 include a left side mirror provided on a left side of the vehicle body 10 and a right side mirror provided on a right side of the vehicle body 10, so that the driver inside the vehicle 1 may acquire visual information about the sides and rear of the vehicle 1.

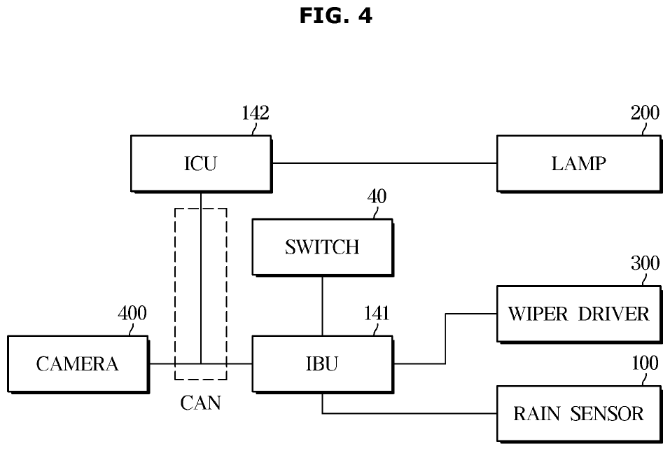

Wipers 330 are provided at a lower side of the windshield glass 11 to wipe a surface of the windshield glass 11. The wipers 330 receive power from a wiper driver 300 (FIG. 4) and may be operated by a detection signal of a rain sensor 100 (FIG. 4) or a command signal of a switch 40 (FIG. 4), which will be described later.

The doors 13 are rotatably provided on the left and right sides of the vehicle body 10, so that the driver may get in the vehicle 1 when opened, and the inside of the vehicle 1 may be shielded from the outside when closed.

In addition to the above-described configurations, the vehicle 1 may include a driving device 16 for rotating the vehicle wheels 21 and 22, a steering device (not shown) for changing a movement direction of the vehicle 1, and a braking device (not shown) for braking movement of the wheels.

The driving device 16 provides rotational force to the front wheels 21 or the rear wheels 22, so that the vehicle body 10 moves forward or backward. The driving device 16 may include an engine that generates a rotational force by burning fossil fuel or a motor that generates the rotational force by receiving power from a battery (not shown).

The steering device may include a steering wheel 42 (FIG. 2) that receives a driving direction from the driver, a steering gear (not shown) that converts rotational motion of the steering wheel 42 into a reciprocating motion, and a steering link (not shown) that transmits the reciprocating motion of the steering gear (not shown) to the front wheels 21. The steering device may change a driving direction of the vehicle 1 by changing a direction of a rotation shaft of a wheel.

The braking device may include a brake pedal (not shown) that receives a braking operation from the driver, a brake drum (not shown) connected to the vehicle wheels 21 and 22, a brake shoe (not shown) that brakes a rotation of the brake drum (not shown) using frictional force, and the like. The braking device may brake the vehicle 1 by stopping the rotation of the wheels 21 and 22.

The interior of the vehicle 1 may include a dashboard 14 where a variety of devices for operating the vehicle 1 are installed, a driver's seat 15 where the driver of the vehicle 1 is seated, cluster display parts 51 and 52 for displaying operation information of the vehicle 1, etc., and a navigation 70 for providing route information according to an operation command of the driver as well as audio and video functions.

The dashboard 14 is provided to be protruded from a lower portion of the windshield glass 11 towards the driver, and allows the driver to operate various devices installed on the dashboard 14 while looking at the front.

The driver's seat 15 is provided at the rear of the dashboard 14, so that the driver may stably operate the vehicle 1 while looking at the front of the vehicle 1 and various devices of the dashboard 14.

A camera 400 has a front view of the vehicle 1 and acquires image data. The camera 400 is a type of black box and corresponds to a drive video record system (DVRS) as a built-in cam located behind a rearview mirror. The camera 400 may record at all times during driving or store an image when an external shock occurs or in a specific situation to provide a user with image data that may be used as proof data later. The camera 400 is a built-in cam and may include a G-sensor.

The cluster display parts 51 and 52 are provided on the driver's seat 15 side of the dashboard 14, and may include the speed gauge 51 indicating a travelling speed of the vehicle 1 and the revolutions per minute (RPM) gauge 52 indicating a rotation speed of the driving device (not shown).

The navigation 70 may include a display for displaying information about a road on which the vehicle 1 travels or a route to a destination of the driver and a speaker 41 that outputs a sound in response to a driver's operation command. Recently, an audio, video, navigation (AVN) device in which an audio device, a video device and a navigation device are integrated has been installed in a vehicle.

The navigation 70 may be installed on a center fascia. In this instance, the center fascia refers to a control panel portion between the driver's seat 15 and a front passenger seat in the dashboard 14. The center fascia is an area where the dashboard 14 and a shift lever meet vertically, and the navigation 70 as well as controllers of an air conditioner and heater, an air vent, a cigarette lighter jack, an ashtray, a cup holder, etc., may be installed thereon. The center fascia and a center console may also separate the driver's seat 15 from the front passenger seat.

In addition, a jog dial 60 may be separately provided to operate various devices including the navigation 70.

The jog dial 60 according to embodiments of the disclosure may be operated by rotating or applying pressure and may perform handwriting recognition using a user's fingers or a tool having a separate touch recognition function by including a touch pad.

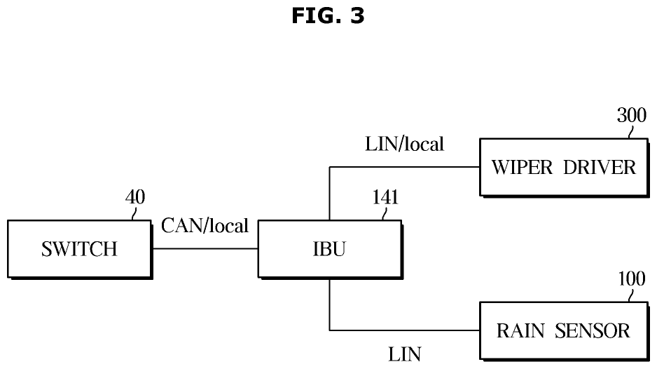

FIG. 3 illustrates a signal flow graph of an existing rain sensor system.

The rain sensor system may include a switch 40, an integrated body control unit (IBU) 141 which is a controller, a wiper driver 300 that transmits power to the wipers 330 (FIG. 1), and the rain sensor 100 that monitors the amount of received total reflection and the amount of diffused reflection reflected from the windshield glass 11 (FIG. 1) to detect foreign substances and determine a degree of contamination of the windshield glass 11.

The switch 40 is an input device for operating various functions or electronic devices of the vehicle 1. The switch 40 may be a multifunction steering wheel (MFSW) provided on the steering wheel (not shown).

A driver may operate various functions of the wipers 330 using the switch 40. The switch 40 may have a variety of functions such as Mist, OFF, INT, LO, HI, AUTO, spraying washer fluid, and the like.

‘Mist’ is a function for operating the wipers 330 one time when the switch 40 is operated for less than a predetermined period of time, and ‘OFF’ is a function for ending the operation of the wipers 330. ‘INT’ is a function for intermittently operating the wipers 330 rather than continuously operating the wipers 330. TO′ and ‘HI’ are functions for adjusting a speed of the wipers 330. The switch 40 may receive a user command for controlling ‘on’ and ‘off’ of the wiper driver 300. ‘AUTO’ is a function for the wiper driver 300 to be automatically operated according to detection of rainfall and the amount of rain based on a detection signal of the rain sensor 100.

The rain sensor 100 detects rainfall and provides a signal for operating the wipers 330 to the wiper driver 300. The rain sensor 100 transmits a rain detection signal to the IBU 141 through a local interconnect network (LIN), and the IBU 141 controls the wiper driver 300 through a relay signal or LIN depending on the vehicle 1.

The rain sensor 100 may determine the amount of change in rain which is in contact with the windshield glass 11 and transmit rain detection signals having different indices depending on the amount of change in rain to the IBU 141. The wiper driver 300 may adjust a rotation speed of the wipers 330 depending on a signal level transmitted from the IBU 141.

Meanwhile, when the switch 40 is in an automatic mode, because a signal output from the rain sensor 100 is transmitted only to the wiper driver 300, the signal output from the rain sensor 100 is only involved in the operation of the wipers 330. In this instance, when the signal output from the rain sensor 100 is widely applied to a data bus system of the vehicle 1, a risk occurring when a large amount of rain falls on the windshield glass 11 may be reduced in various aspects.

The operations described above may be equally applied to FIGS. 4 to 8. According to embodiments of the disclosure, however, the signal output from the rain sensor 100 is utilized for a controller area network (CAN), thereby performing an additional function when the switch 40 is in the AUTO mode.

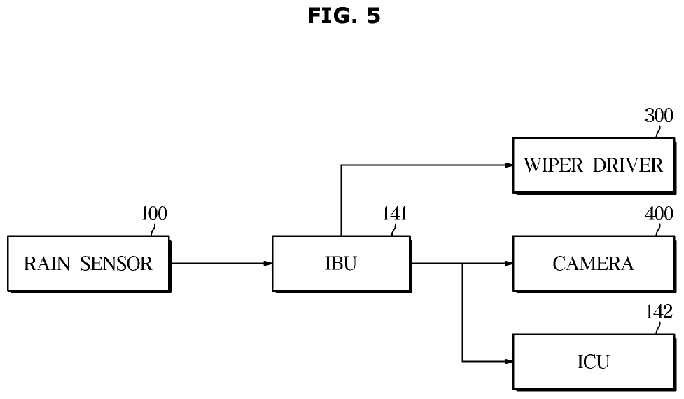

FIG. 4 is a diagram illustrating a configuration of a rain sensor system according to an embodiment. FIG. 5 illustrates a signal flow graph of a rain sensor system according to an embodiment.

According to the present embodiment, the switch 40 may additionally have a power mode, in addition to Mist, OFF, INT, LO, HI, AUTO, and spraying washer fluid functions. Unlike the LO, HI and AUTO functions, in the power mode, a wiping speed and a movement radius of the wipers 330 are adjusted, and the power mode may be activated by a driver's operation or a signal of the rain sensor 100 when securing a view quickly is required.

In this instance, the wiper driver 300 is an electronic control wiper (ECW) and operates by being connected to the IBU 141 which is a first controller through LIN. Unlike a wiper driven by a general DC motor, the wiper driver 300 may determine and control a position of the wiper by itself. An effect of increasing RPM may be generated when an angle is adjusted while maintaining a speed of the motor (not shown). Accordingly, when a relatively high wiping speed is required (splash signal detection), the wiper driver 300 adjusts a wiping angle to increase the wiping speed.

The rain sensor system according to the present embodiment may control at least one electronic device. The electronic device may be operated based on a control signal of an integrated central control unit (ICU) 142 which is a second controller. Here, the electronic device is a device mounted on the vehicle 1 that may help safety when driving in the rain and may include a lamp 200, the camera 400, and a communicator (not shown).

The lamp 200 is an output device capable of implementing an emergency stop signal (ESS) function and may notify a rear vehicle of a risk of rear collision due to sudden braking. When detecting a change rate greater than or equal to a reference value based on a speed change rate of the vehicle 1, the ICU 142 generates a control signal, and the lamp 200 blinks based on the control signal to notify the rear vehicle of an emergency.

According to an embodiment, the ICU 142 may receive a signal from the IBU 141, generate the control signal based on the received signal, and control at least one electronic device through the control signal.

According to an embodiment, the IBU 141 may generate a control signal for allowing the wiper driver 300 to operate in a power mode. In this instance, the control signal of the ICU 142 may be generated based on a splash signal of the rain sensor 100. The splash signal may be generated when rain greater than or equal to the predetermined amount is detected by the rain sensor 100 and may be generated when the amount of change in rain is abnormal due to instantaneous friction between a road surface and tires of a nearby vehicle.

The splash signal transmitted to the IBU 141 may allow a CAN signal which is the control signal of the ICU 142 to be additionally generated and referenced by a controller that controls another electronic device.

According to an embodiment, the ICU 142 may control a memory (not shown) to store image data, acquired by the camera 400, based on the control signal.

Also, according to an embodiment, the ICU 142 may control the lamp 200 to blink based on the control signal, thereby notifying a rear vehicle of an emergency.

In addition, according to an embodiment, the ICU 142 may control the communicator (not shown) to transmit a warning signal based on the control signal. When the control signal is received, the communicator may provide the warning signal to a nearby vehicle so that a driver of the nearby vehicle may recognize the emergency through a cluster or navigation. In this instance, the communicator may use a vehicle to vehicle (V2V) communication method.

Referring to FIG. 5, the rain sensor 100 transmits a detection signal (e.g., a splash signal) to the IBU 141 through LIN. In this instance, the IBU 141 transmits the detection signal to the wiper driver 300 through LIN to control the wiper driver 300.

However, the IBU 141 provides the detection signal to a controller that controls electronic devices other than the wiper driver 300 through CAN. For example, the IBU 141 transmits the detection signal to the ICU 142 through CAN, allowing the ICU 142 to generate a control signal for controlling at least one electronic device. Also, the IBU 141 transmits the detection signal to the camera 400 through CAN, controlling the camera 400 to acquire image data.

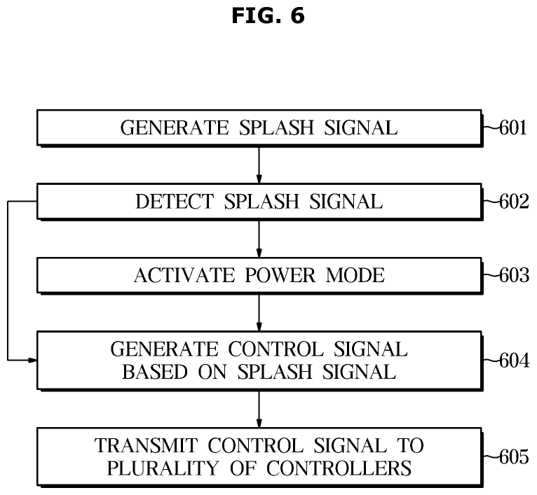

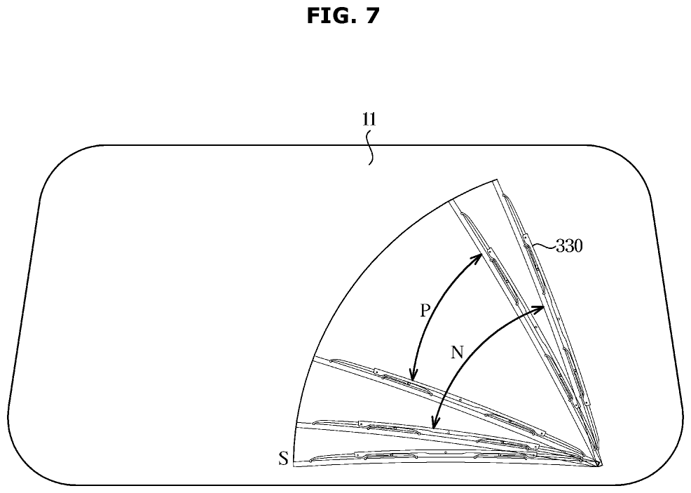

FIG. 6 is a flowchart illustrating a control method of a vehicle according to an embodiment. FIG. 7 is a diagram illustrating an operation radius of a wiper in a power mode of a rain sensor system according to an embodiment.

The rain sensor 100 generates a splash signal (601). In this instance, the splash signal may be generated when the amount of change in rain on the windshield glass 11 is abnormal due to instantaneous friction between a road surface and tires of a nearby vehicle.

The IBU 141 detects the splash signal (602) and controls the wiper driver 300 so that a power mode is activated based on the splash signal (603).

Referring to FIG. 7, in a state where the switch 40 is in an ‘OFF’ state, the wipers 330 are fixed (S) to a lower side of the windshield glass 11. When the switch 40 is in ‘LO’, ‘HI’ or ‘AUTO’ state or rain less than a predetermined amount is detected by the rain sensor 100, the wipers 330 move within a basic radius (N).

Meanwhile, in a power mode, an effect of increasing RPM may be generated when an angle is adjusted while maintaining a speed of a motor (not shown), and thus relatively fast wiping may be performed by the wiper driver 300. Accordingly, in the power mode, a wiping speed may be increased by reducing a wiping angle (N→P).

According to an embodiment, when the splash signal is detected, the power mode that reduces the wiping angle of the wipers 330 is activated, and the wiper driver 300 may operate the wipers 330 according to the power mode. Also, the wiping speed may be increased in the power mode. Higher wiping speed means shorter wiping cycles. That is, the wiping cycle may be shortened in the power mode.

The ICU 142 generates a control signal based on the splash signal (604) and transmits the control signal to a plurality of controllers that control a plurality of electronic devices (605).

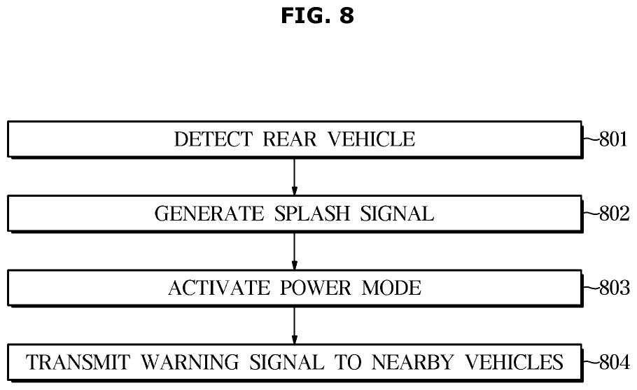

Meanwhile, according to embodiments of the disclosure, a splash signal may be generated based on detection of a rear vehicle, not based on the detection signal of the rain sensor 100, in order to prepare for a sudden emergency, which is described in detail with reference to FIG. 8.

FIG. 8 is a flowchart illustrating a control method of a vehicle according to another embodiment.

The vehicle 1 detects a rear vehicle (801). The vehicle 1 may detect other vehicles around the vehicle 1 by including a radar (not shown), a rear camera (not shown), and/or a lidar (not shown).

The vehicle 1 generates a splash signal in response to detection of the rear vehicle (802). The splash signal may be generated by the rain sensor 100 or through an ICU connected to the radar, the rear camera and/or the lidar and may be transmitted through CAN.

When the splash signal is detected, the vehicle 1 activates a power mode (803). In this instance, because the power mode is not based on a detection signal generated by the rain sensor 100, the power mode is for securing a view before rainfall on the windshield glass 11 is detected.

According to an embodiment, when a nearby vehicle is detected within a predetermined distance from a rear of the vehicle 1, the vehicle 1 may control the wiper driver 300 so that the power mode is automatically activated.

Also, according to an embodiment, when a speed of the vehicle 1 is greater than or equal to a reference speed, the vehicle 1 may control the wiper driver 300 so that the power mode is automatically activated. In this instance, the speed of the vehicle 1 or a speed of the rear vehicle approaching from the rear may be the reference speed.

Together with the activation of the power mode, the vehicle 1 may control a communicator (not shown) to transmit a warning signal to nearby vehicles (804).

As is apparent from the above, according to the embodiments of the disclosure, the vehicle and the control method thereof can reduce a risk of accident caused when a large amount of rain splashes on a windshield of the vehicle when driving in the rain and can prevent secondary accidents by automatically taking a separate action even when a driver's field of view may not be secured.

Embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include read only memory (ROM), random access memory (RAM), magnetic tapes, magnetic disks, flash memories, and an optical recording medium.

Although embodiments have been described for illustrative purposes, those skilled in the art will appreciate that various modifications, additions and substitutions are possible, without departing from the scope and spirit of the disclosure. Therefore, embodiments have not been described for limiting purposes.

What is claimed is:

1. A vehicle comprising:
a rain sensor configured to generate a splash signal in response to detecting rain greater than or equal to a predetermined amount;
a wiper driver configured to operate a wiper based on the splash signal;
a first controller configured to transmit the splash signal to the wiper driver; and
a second controller configured to receive the splash signal from the first controller, generate a control signal based on the splash signal, and operate at least one electronic device based on the control signal.

2. The vehicle of claim 1, wherein the wiper driver is configured to operate the wiper according to a power mode for reducing a wiping angle of the wiper when the splash signal is detected.

3. The vehicle of claim 2, wherein the wiper driver is configured to shorten a wiping cycle of the wiper in the power mode.

4. The vehicle of claim 2, wherein:
the at least one electronic device includes a camera mounted on the vehicle and configured to acquire image data including a front image or a rear image; and
the second controller is configured to control a memory to store the image data based on the control signal.

5. The vehicle of claim 2, wherein:
the at least one electronic device includes a communicator configured to transmit and receive data with a nearby vehicle; and
the second controller is configured to control the communicator to transmit a warning signal to the nearby vehicle in response to receiving the control signal.

6. The vehicle of claim 2, wherein:
the at least one electronic device includes a lamp configured to blink in an emergency; and
the second controller is configured to control the lamp to blink in response to receiving the control signal.

7. The vehicle of claim 2, wherein the power mode is automatically activated in the wiper driver when a nearby vehicle is detected within a predetermined distance from a rear of the vehicle.

8. The vehicle of claim 7, wherein the rain sensor is configured to generate the splash signal in response to detection of the nearby vehicle.

9. The vehicle of claim 8, further comprising a communicator configured to transmit and receive data with the nearby vehicle, wherein the second controller is configured to control the communicator to transmit a warning signal to the nearby vehicle in response to detection of the nearby vehicle.

10. The vehicle of claim 2, wherein the power mode is automatically activated in the wiper driver when a speed of the vehicle is greater than or equal to a predetermined speed.

11. A control method of a vehicle comprising a rain sensor, a wiper driver, a first controller, and a second controller, the control method comprising:
generating, by the rain sensor, a splash signal in response to detecting rain greater than or equal to a predetermined amount;
operating, by the wiper driver, a wiper based on the splash signal;
transmitting, by the first controller, the splash signal to the wiper driver;
receiving, by the second controller, the splash signal from the first controller;
generating, by the second controller, a control signal based on the splash signal; and
operating, by the second controller, at least one electronic device based on the control signal.

12. The control method of claim 11 wherein operating the wiper comprises operating the wiper according to a power mode for reducing a wiping angle of the wiper.

13. The control method of claim 12, wherein a wiping cycle of the wiper is shortened in the power mode.

14. The control method of claim 12, wherein operating the at least one electronic device comprises controlling a memory to store image data obtained by a camera mounted on the vehicle based on the control signal.

15. The control method of claim 12, wherein operating the at least one electronic device comprises controlling a communicator to transmit a warning signal to a nearby vehicle in response to receiving the control signal.

16. The control method of claim 12, wherein operating the at least one electronic device comprises controlling a lamp to blink in response to receiving the control signal.

17. The control method of claim 12, further comprising automatically activating the power mode when a nearby vehicle is detected within a predetermined distance from a rear of the vehicle.

18. The control method of claim 17, further comprising generating the splash signal in response to detection of the nearby vehicle.

19. The control method of claim 18, wherein operating the at least one electronic device comprises controlling a communicator to transmit a warning signal to the nearby vehicle in response to detection of the nearby vehicle.

20. The control method of claim 12, further comprising automatically activating the power mode when a speed of the vehicle is greater than or equal to a predetermined speed.
